(19) United States
(12) Patent Application Publication
(10) Pub. No.: US 2001/0030936 A1
(43) Pub. Date: Oct. 18, 2001

(54) Method of conversion of a turntable to a musical instrument

(76) Inventor: Jonathan Cass, Burlington (CA)

Correspondence Address: ROBERT F. DELBRIDGE, GOWLING LAFLEUR HENDERSON LLP, 120 KING STREET WEST, SUITE 560, PO BOX 1045, LCD 1, HAMILTON, ON, L8N 3R4, CA

(21) Appl. No.: 09/735,905

(22) Filed: Dec. 14, 2000

Related U.S. Application Data
(60) Provisional application No. 60/171,104, filed on Dec. 16, 1999.
(60) Provisional application No. 60/226,898, filed on Aug. 23, 2000.

(51) Int. Cl. G11B 3/74; G11B 7/20

(52) U.S. Cl. 369/277; 369/93

(57) ABSTRACT

A turntable record has a track with at least one scale of notes and/or series of chords of a predetermined musical key, the scale being diatonic, pentatonic, whole tone or one of the modes.

This invention relates to the provision of new creative options for disk jockeys, some of which are referred to as “scratchers.”

### BACKGROUND OF INVENTION

A disk jockey used to be a person who simply selected and played records on a turntable sound system for entertainment purposes. Over the course of time, disk jockeys have developed methods of employing multiple turntables with manual manipulation and state-of-the-art mixing equipment to combine portions of existing recordings of music or other artistic performances, often with variations in pitch and rhythm to give an audience a new form of entertainment. Turntable manufacturers develop and market products meant especially for such use, but records currently available to such creative disk jockeys are somewhat limited.

It is therefore an object of the invention to provide turntable records which will give a disk jockey the ability to make his or her turntable into a musical instrument with which he or she can compose in the same way and with the same music theory as other instrumentalists, such as those who play wind and stringed instruments.

### SUMMARY OF INVENTION

According to the invention, turntable records are provided which each have a track with at least one scale of notes and/or series of chords of a predetermined key, with the notes and/or chords on the track each lasting for a predetermined time. There may be silence for a predetermined time between adjacent notes and/or chords. For example, each note and/or chord may last for 10 seconds, and each silence may last for 1 second.

The scale may be diatonic, pentatonic, whole tone or one of the modes. The notes of a scale may be in their natural order or may be in a random order. For example, the diatonic C major scale may be presented in the usual order, namely c d e f g a b c, or in a random order such as c f a c d b e g.

The scale of notes and/or series of chords provided on a first track may be provided in a different manner on another track, for example with each note and/or chord lasting for another predetermined time or with the notes and/or chords having a different volume or a different quality to resemble a particular instrument. Adjacent tracks on a record may be unconnected or connected to each other.

### DESCRIPTION OF PREFERRED EMBODIMENTS

In one embodiment of the invention, a C major record has multiple separate tracks each having a different ascending and descending version of the diatonic C major scale, with the notes having a different length of time from track to track. The record is appropriately marked to indicate the identity of the notes (and/or related chords if provided) at their position on a track. Track 1 may have the notes c d e f g a b c b a g f e d c, with each note lasting 10 seconds and with there being a silence of 1 second between each note. Track 2 has the same notes as track 1, but with each note lasting only 5 seconds. Track 3 has the same notes, but with each note lasting only 2 seconds. Other tracks with different note lengths may be provided.

Instead of diatonic, the scale may be pentatonic, whole tone or one of the modes, the nature of which is well known to a musician.

There is a turntable record for each scale, and additional records may be provided to give the disk jockey a means of providing sounds resembling different instruments.

In use, a record is mounted on a conventional turntable with a swing arm and needle. Having selected a record and positioned the needle on the appropriate track, the disk jockey can manually control the timing of the sound desired physically, for example by placing his or her hand on the record to stop it (i.e. so that the record slips on the turntable as the turntable rotates) until the moment when production of the sound is desired.

The advantages of the present invention will now be readily apparent to a person skilled in the art from the foregoing description of preferred embodiments. Other embodiments will also now be readily apparent, the scope of the invention being defined in the appended claims.

1. A turntable record having a track with at least one scale of notes and/or series of chords of a predetermined musical key, the scale being diatonic, pentatonic, whole tone or one of the modes.

2. A record according to claim 1 wherein there is silence for a predetermined time between adjacent notes and/or chords.

3. A record according to claim 1 wherein said track is provided with a scale of notes in their natural order.

4. A record according to claim 1 wherein said track is provided with a scale of notes in a random order.

5. A record according to claim 1 wherein the scale of notes and/or series of chords provided on said track are provided in a different manner on another track.

6. A record according to claim 5 wherein said track and said other track are unconnected.

7. A record according to claim 5 wherein said track is connected to said other track.
